(19) United States
(12) Patent Application Publication
(10) Pub. No.: US 2009/0023440 A1
(43) Pub. Date: Jan. 22, 2009

(54) Communication mediation apparatus and communication mediation method

(75) Inventor: Makoto Saotome, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/213,018

(22) Filed: Jun. 12, 2008

(30) Foreign Application Priority Data
Jul. 18, 2007 (JP) 2007-187264

(51) Int. Cl. H04Q 7/34

(52) U.S. Cl. 455/424

(57) ABSTRACT

A communication mediation apparatus for mediating communication between an information processing device and a communication network includes a first communication unit, second communication unit, a determining unit, and a setting unit. The first communication unit communicates with the information processing device by first communication speed. The second communication unit communicates with the communication network having multiple second communication speeds. The determining unit determines the second communication speed being closest to the first communication speed from among the multiple second communication speeds. The setting unit sets the determined communication speed to the second communication unit.

### BACKGROUND

1. Field of the Technique

The present technique relates to a communication mediation apparatus for mediating communication between a communication network and an information processing device.

2. Description of the Related Art

In recent years, cell phones have been allowed to easily access a network such the Internet via a telephone network as an information terminal. On the other hand, many of information processing devices such as personal computers (PCs) that are able to process even greater amounts of information than cell phones include no means for communicating with a telephone network wirelessly, unlike cell phones. Thus, it is difficult for such information processing devices to independently perform easy access as described above. As an example of a technology for allowing an information processing device to perform such easy access, a technology is known that connects a cell phone to the information processing device by wire and then causes the cell phone to mediate communications between the information processing device and the telephone network.

If an attempt is made to perform communications between a and a telephone network and if the PC has no function of directly communicating with the telephone network, communications are performed between the PC and telephone network by connecting a cell phone to the PC. Here, various interfaces such as a universal asynchronous receiver-transmitter (UART), a universal serial bus (USB), and a wireless local area network (LAN) may be used. However, these interfaces support different communication speeds.

If the communication speed between the PC and cell phone is different from the communication speed between the cell phone and telephone network when communications are performed between the PC and telephone network, information may not be smoothly communicated. For example, if the communication speed between the PC and cell phone is lower than the communication speed between the cell phone and telephone network, the cell phone may not fully transfer data received from the telephone network to the PC. As a result, the received data may reside in the cell phone.

Also, the cell phone may issue, to the telephone network, a transmission command for connecting between the cell phone and the telephone network at the highest communication speed settable therebetween. However, if the communication speed between the PC and cell phone does not reach the highest communication speed, communications between the PC and cell phone become a bottleneck, leaving the cell phone and telephone network connected at an unnecessary high communication speed. Since there is an upper limit to the communication band of the base station of the cell phone, the communication band is exhausted if the cell phone and telephone network are left connected at the unnecessary high communication speed. This interferes with communications performed by other cell phones, thereby preventing smooth communications.

If the cell phone is used to mediate communications between the PC and the telephone network, the communication speed between the cell phone and telephone network may be set up by a manual operation of a user. In this case, almost no consideration is given to the communication speed between the cell phone and PC. This is one of causes for which smooth communications are prevented when using the cell phone as a communication mediation apparatus.

### SUMMARY

It is an object of this technique to provide a communication mediation apparatus that smoothly mediates communications.

According to an aspect of an embodiment, a communication mediation apparatus for mediating communication between an information processing device and a communication network includes a first communication unit, second communication unit, a determining unit, and a setting unit. The first communication unit communicates with the information processing device by first communication speed. The second communication unit communicates with the communication network having multiple second communication speeds. The determining unit determines the second communication speed being closest to the first communication speed from among the multiple second communication speeds. The setting unit sets the determined communication speed to the second communication unit.

### BRIEF DESCRIPTION OF THE DRAWINGS

FIG. 1 is a schematic view showing a communication system;

FIG. 2 is a block diagram of a cell phone shown in FIG. 1; and

FIG. 3 is a flowchart showing a flow of a process of mediating communication between a notebook PC and a base station shown in FIG. 1.

### DESCRIPTION OF THE PREFERRED EMBODIMENTS

An embodiment will now be described with reference to the accompanying drawings.

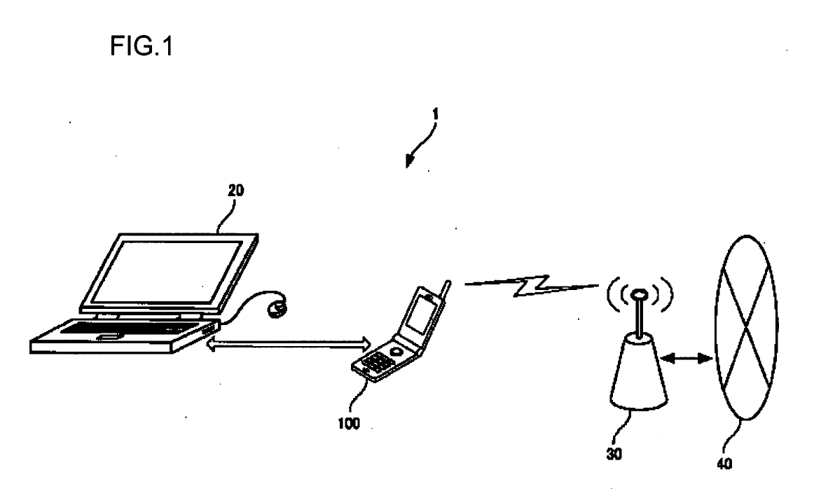

FIG. 1 is a schematic view showing the communication system to which this embodiment is applied.

A communication system shown 1 in FIG. 1 includes a cell phone 100, a notebook personal computer (hereafter referred to as a “notebook PC”) 20, a base station 30 of a telephone network including the cell phone 100, and a network 40, such as the Internet, connected to the base station 30. In the communication system 1, communications between the notebook PC 20 and base station 30 are mediated by the cell phone 100. The cell phone 100 is an example of a communication mediation apparatus. The cell phone network including the base station 30 and the network 40 is one example of a communication network also serving as a telephone network. The notebook PC 20 is one example of an information processing device.

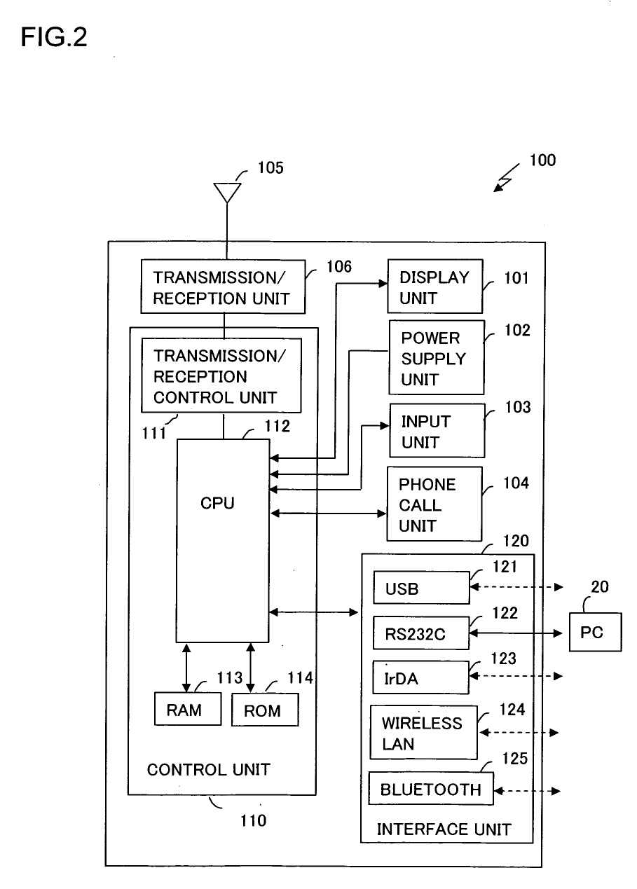

FIG. 2 is a block diagram of the cell phone 100 shown in FIG. 1.

The cell phone 100 includes a display unit 101 for displaying images or characters on a predetermined monitor screen, a power supply unit 102 for outputting power to be provided to components of the cell phone 100, an input unit 103 for receiving information inputted by operating a key, a phone call unit 104 for acquiring and reproducing voice during a phone call, an antenna 105, a transmission/reception unit 106 for performing wireless communications via the antenna 105, a control unit 110 for controlling operations of the cell phone 100 as a whole, and an interface unit 120 for communicating with external devices, such as the notebook PC 20 shown in FIG. 1.

The transmission/reception unit 106 is one example of a second communication unit. It has an interface in conformity with a communication standard defining wireless communications with the base station 30 shown in FIG. 1. The transmission/reception unit 106 wirelessly communicates with the base station 30 via this communication interface.

The control unit 110 includes a transmission/reception control unit 111 for performing communication control, such as setting of the communication speed of wireless communications performed by the transmission/reception unit 106, a CPU 112 for performing the overall control operations of the control unit 110, a RAM 113 for temporarily storing various types of programs and/or information as necessary, and a ROM 114 for storing a control program, communication speed, etc. for the cell phone 100.

If a user places a call using the cell phone 100, the user inputs the telephone number of the party at the other end via the input unit 103 and then the transmission/reception unit 106 accesses the base station 30 according to the inputted telephone number so as to open a communication line. Then, voice acquired by the phone call unit 106 is transmitted from the transmission/reception unit 106 as a voice signal, while voice represented by a voice signal from the party received by the transmission/reception unit 106 is reproduced by the phone call unit 104. Communications between the transmission/reception unit 106 and the base station 30 during this phone call are wirelessly performed at a predetermined communication speed.

The cell phone 100 also has a function of accessing the network 40 shown in FIG. 1 via the base station 30 and acquiring or transmitting information from or onto the network 40. This access to the network 40 is also wirelessly performed.

Further, the cell phone 100 has a function of communicating with external devices such as the notebook PC 20 shown in FIG. 1 in addition to the function of wirelessly communicating with the base station 30. Such communications with the notebook PC 20 are performed via the interface unit 120. The interface unit 120 includes the following five types of communication interfaces.

The interface unit 120 is an example of a first communication unit and includes five types of communication interfaces: a USB interface 121 conforming to a USB standard and for performing wire communications; an RS232-C interface 122 conforming to an RS232-C standard and for performing wire communications; an IrDA interface 123 conforming to an IrDA standard and for performing infrared communications; a wireless LAN interface 124 conforming to a wireless LAN communication standard such as IEEE802.11b and for wirelessly communicating with a wireless LAN-equipped computer or the like, and a interface 125 for performing wireless communications in conformity with a Bluetooth (registered trademark) communication standard. The USB interface 121 includes a USB connector for wire connection and a predetermined processing part. The RS232-C interface 122 includes an RS232-C connector for wire connection and a predetermined processing part. The IrDA interface 123 includes an infrared radiation part, an infrared sensor, and a predetermined processing part. The wireless LAN interface 124 includes a wireless LAN antenna and a predetermined processing part. The interface 125 includes the Bluetooth (registered trademark) antenna and a predetermined processing part.

The user selects a communication interface matching with that of the notebook PC 20, from among these five types of communication interfaces. Then, the CPU 112 of the control unit 110 notifies the interface unit 120 of the selection result. Thus, the cell phone 100 communicates with the notebook PC 20 via the communication interface notified by the CPU 112. FIG. 2 shows an example in which the RS232-C interface 122 is selected as the communication interface.

Further, the cell phone 100 according to this embodiment has a function of mediating communications between the notebook PC 20 and the base station 30 using both the function of communicating with the base station 30 and that of communicating the notebook PC 20. The feature of the cell phone 100 as an embodiment is this communication mediation function. In the following description, attention will be paid to this mediation function.

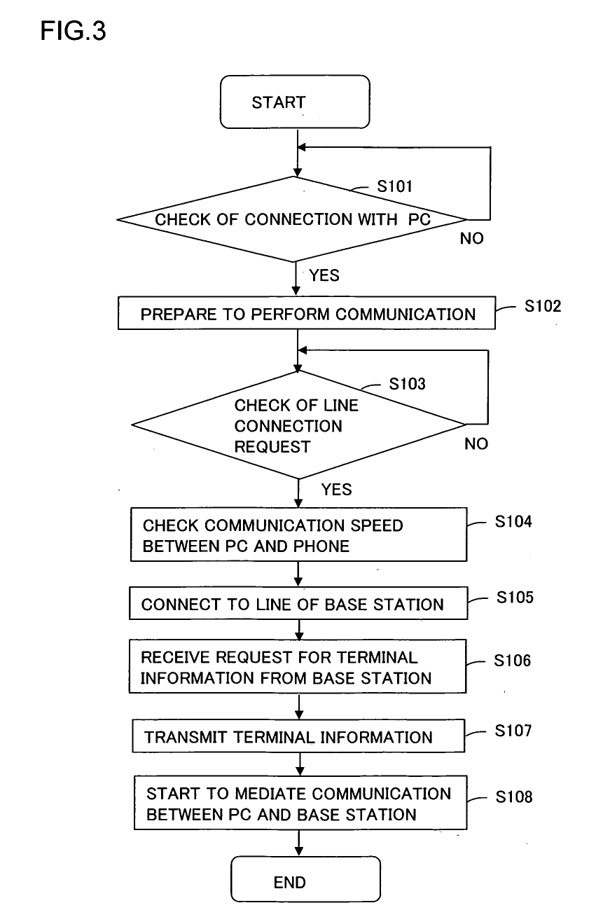

FIG. 3 is a flowchart showing a flow of a process of mediating communications between the notebook PC 20 and base station 30 shown in FIG. 1.

The process shown in FIG. 3 starts when, by performing a predetermined menu operation, the user instructs the cell phone 20 to perform a communication mediation process. The user also instructs the cell phone 20 which of the above-described five types of communication interfaces to be used in this mediation process. Further, when the user instructs the cell phone 100 about the communication interface, the user starts up the notebook PC 20.

When the mediation process is started, the cell phone 100 is brought into a standby state in which the CPU 112 is monitoring whether or not the cell phone 100 and notebook PC 20 has been connected using a connection method corresponding to the instructed communication interface (step S101).

In this embodiment, the monitoring in step 101 is performed as follows: for the USB interface 121, it is checked whether or not a relevant cable has been connected to the USB connector; for RS232-C interface 122, it is checked whether or not a relevant cable has been connected to the RS232-C connector; for IrDA interface 123, it is checked whether or not a response of the notebook PC 20 to a connection request has been received by the infrared sensor; for the wireless LAN interface 124, it is checked whether or not a response of the notebook PC 20 to a connection request has been received by the wireless LAN antenna; and for the interface 125, it is checked whether or not a response of the notebook PC 20 to a connection request has been received by the Bluetooth (registered trademark) antenna.

Once it is checked that the connection has properly been made (YES in step S101), a preparation step for performing communications via the instructed interface is performed according to the specification of the communication interface (step S102).

Upon completion of this preparation step, the cell phone 100 is brought into a standby state in which it is monitored whether or not a line connection request of the notebook PC 20 to the base station 30 has been issued (step S103).

Once it is checked that a line connection request of the notebook PC 20 has been issued (YES in step S103), the communication speed between the notebook PC 20 and cell phone 100 (first communication speed) is checked (step S104).

In this embodiment, the cell phone 100 performs communications: at three communication speeds, a low speed (1.5 Mbps), a full speed (12 Mbps), and a high speed (480 Mbps), via the USB interface 121; at multiple communication speeds in the range of 600 bps to 460.8 kbps via the RS232-C interface 122; at two communication speeds, 115.2 kbps defined by the IrDA standard version 1.0 and 4 Mbps defined by the IrDA standard version 1.1, via the IrDA interface 123; at two communication speeds, 11 Mbps defined by the IEEE802.11b and 54 Mbps defined by the IEEE802.11a/g, via the wireless LAN interface 124; or at a communication speed of 720 kbps defined by the Bluetooth (registered trademark) version 1.1 communication standard via the interface 125.

In step S104, it is checked which of the above-described communication speeds is preliminarily supported by the cell phone 100.

After the first communication speed has been checked, the transmission/reception unit 106 is connected to a line of to the base station 30 according to an instruction from the CPU 112 (step S105). Then, a request for providing predetermined terminal information on the cell phone 100 is transmitted from the base station 30 (step S106).

Once the cell phone 100 has received the above-described request, the CPU 112 creates terminal information according to the received instruction. At that time, second communication speed between the cell phone 100 and the base station 30 is determined on the base of the first communication speed. The CPU 112 determines the second communication speed being closest to the first communication speed from among multiple communication speeds available in communications with the base station 30. The CPU 112 is one example of a determining unit. It is incorporated into the terminal information. Then, the transmission/reception unit 106 transmits the created terminal information to the base station according to an instruction of the CPU 112 (step S107). Note that the interactions between the cell phone 100 and base station 30 from step S105 to step S107 are performed at a predetermined default communication speed.

Then, the base station 30 recognizes the second communication speed desired by the cell phone 100 from the terminal information transmitted in step S107. In the cell phone 100, the transmission/reception control unit 111 sets the second communication speed incorporated into the above-described terminal information, in the transmission/reception unit 106. The transmission/reception control unit 111 is one example of a setting unit. Thus, the CPU 112 determines the second communication speed being closest to the first communication speed.

Once the communication speed between the cell phone 100 and base station 30 has been set, the notebook PC 20 and base station 30 start to communicate with each other through mediation of the cell phone 100 (step S108). Thus, the notebook PC 20 receives or transmits information from or onto the network 40 connected to the base station 30.

During the communications, the CPU 112 performs control in the cell phone 100 so that information received from the notebook PC 20 by the interface unit 120 is transmitted to the base station 30 by the transmission/reception unit 106 and information received from the base station 30 by the transmission/reception unit 106 is transmitted to the notebook PC 20 by the interface unit 120.

By performing the above-described mediation process, the degree of matching between the first communication speed between the notebook PC 20 and cell phone 100 and the second communication speed between the cell phone and the network 40 via the base station 30 is increased. As a result, when communications are performed between the notebook PC 20 and network 40, communicated information is prevented from residing or being exhausted in the cell phone 100, thereby allowing smooth communications.

While the interface unit 120 having the five types of communication interfaces has been shown as an example of the first communication unit in this embodiment, the first communication unit may include six or more types of communication interfaces or four or less types of communication interfaces. Also, the communication interfaces may be of types other than the above-described five types of communication interfaces.

Also, it may be checked which of the above-described communication speeds is supported by the cell phone 100 so that the communication speed of the cell phone 100 corresponds to the communication speed set up in the notebook PC 20.

While the cell phone 100 has been shown as an example of the communication mediation apparatus, the communication mediation apparatus may be a data communication card, a personal data assistant (PDA), or the like that is able to communicate with both an information processing device and a base station.

While an example has been shown in which a notebook PC exchanges information with a network such as the Internet through mediation of communications of information between the notebook PC and a base station (network of cell phones) by a cell phone, among other examples in which the communication mediation apparatus according to this embodiment is used is one in which a notebook PC exchanges information with another notebook PC via a telephone network.

What is claimed is:

1. A communication mediation apparatus for mediating communication between an information processing device and a communication network, comprising:
a first communication unit for communicating with the information processing device by first communication speed;
a second communication unit for communicating with the communication network having multiple second communication speeds;
a determining unit for determining the second communication speed being closest to the first communication speed from among the multiple second communication speeds; and
a setting unit for setting the determined communication speed to the second communication unit.

2. The communication mediation apparatus according to claim 1, wherein the first communication unit has interfaces of multiple types of communication standards and performs a communication with the information processing device by using selected one of multiple types of communication standards.

3. The communication mediation apparatus according to claim 1, wherein the second communication unit wirelessly performs a communication of information with the communication network.

4. The communication mediation apparatus according to claims 1, wherein the first communication unit performs a communication with the information processing device by wire.

5. The communication mediation apparatus according to claims 1, wherein the first communication unit performs a communication with the information processing device wirelessly.

6. A method for mediating communication between an information processing device and a communication network, comprising the step of:
providing a first communication unit for communicating with an information processing device by first communication speed and a second communication unit for communicating with the communication network having multiple second communication speeds;
determining second communication speed being closest to the first communication speed from among the multiple second communication speeds; and
setting the determined communication speed to the second communication unit.
